(19) United States
(12) Patent Application Publication
(10) Pub. No.: US 2022/0196850 A1
(43) Pub. Date: Jun. 23, 2022

(54) TIME FREE POSITION DETERMINATION OF A ROVING RECEIVER USING A REFERENCE RECEIVER

(71) Applicant: Albora Technologies Limited, Ilford (GB)

(72) Inventors: Miquel Ribot, Barcelona (ES); Adrià Gusi, Barcelona (ES); Xiao Liu, Barcelona (ES); Pau Closas, London (GB)

(21) Appl. No.: 17/127,803

(22) Filed: Dec. 18, 2020

(51) Int. Cl. G01S 19/44; G01S 19/09; G01S 19/04; G01S 19/24

(52) U.S. Cl. CPC G01S 19/44; G01S 19/246; G01S 19/04; G01S 19/09

(57) ABSTRACT

A time-free position determination of a roving receiver includes acquiring from a snapshot receiver in a cloud executing process, a snapshot position of the snapshot receiver received by the snapshot receiver for a single epoch from a constellation of global positioning satellites, the snapshot position including a multiplicity of time-free observables. The method additionally includes retrieving into the cloud executing process baseline position data for a fixed receiver received from the constellation and comprising time-referenced observables. Finally, the method includes compositing in the cloud executing process the time-free observables of the snapshot position with the time referenced observables of the baseline position data to produce time and position data for the snapshot receiver.

### BACKGROUND OF THE INVENTION

### Field of the Invention

The present invention relates to the field of real-time kinematic (RTK) position determination in satellite-based global positioning systems.

### Description of the Related Art

RTK positioning is a satellite navigation technique used to enhance the precision of position data derived from satellite-based positioning systems referred to as global navigation satellite systems (GNSS) and exemplified by the global positioning system (GPS), Global Navigation Satellite System (GLONASS), Galileo, NavIC and BeiDou. RTK employs measurements of the phase of the carrier wave of each satellite signal received in the RTK receiver, in addition to the information content of the signal and then relies upon a single reference station or interpolated virtual station in order to provide real-time corrections. The result is typically on the order of centimeter-level accuracy.

A traditional RTK receiver both receives satellite signals and also processes the signals in order to produce position data. The latter exercise substantially increases the processing resource requirements of the underlying host computing platform of the RTK receiver. Of course, increased processing requirements may result in a larger physical footprint, and therefore geometry and weight of the RTK receiver, thereby limiting the utility of the RTK receiver in many Internet of Things (IoT) applications in which a small, lightweight footprint is required. As well, a host computing platform able to deliver the requisite processing resources for RTK necessarily draws more power requiring a larger power source, e.g. a battery of substantial size and weight, thus only compounding the problem of RTK for smaller, more lightweight applications.

RTK receivers generally require near continuous acquisition of positioning data from a satellite constellation in order to support the real-time positioning of a device. Because the RTK receiver in this instance receives positioning data over several epochs, ample data exists—particularly time-based data-in order to tune the raw positioning information received from the satellite constellation into accurate positioning information. But, the continuous acquisition of positioning data over a number of epochs also is not without consequence. Specifically, the continuous acquisition of positioning data consumes power which, again, inhibits the ability to miniaturize the RTK receiver. Yet, without ingesting positioning data over a number of epochs, insufficient time-based data will be present for use in properly tuning the raw satellite harvested positioning data.

### BRIEF SUMMARY OF THE INVENTION

Embodiments of the present invention address deficiencies of the art in respect to RTK positioning and provide a novel and non-obvious method, system and computer program product for time-free position determination of a roving receiver using a reference receiver. In an embodiment of the invention, a method for time-free position determination of a roving receiver includes first acquiring from a snapshot receiver in a cloud executing process, a snapshot position of the snapshot receiver, the snapshot position having been received by the snapshot receiver for only a single epoch and the snapshot position having been received from a constellation of global positioning satellites. In this regard, the snapshot position includes a multiplicity of time-free observables as opposed to time-based observables.

Thereafter, the method additionally includes retrieving into the cloud executing process, baseline position data for a fixed receiver received from the constellation and comprising time-referenced observables. Finally, the method includes compositing in the cloud executing process the time-free observables of the snapshot position with the time referenced observables of the baseline position data to produce time and position data for the snapshot receiver. In this way, the signal snapshot received from the satellite constellation in the snapshot receiver over only a single epoch can be tuned to produce centimeter-level accuracy despite the absence of time-referenced observables in the snapshot position.

In one aspect of the embodiment, the time-free observables are a set of code-range measurements and corresponding carrier phase measurements. In another aspect of the embodiment, the compositing comprises computing an integer ambiguity resolution (IAR) for the snapshot position based upon both the code-range measurements and also the carrier phase measurements of the time-free observables and also code-range measurements and carrier-phase measurements of the time-referenced observables. In this regard, the time-free observables are pre-processed prior to IAR by first extrapolating a set of full pseudo-ranges for the snapshot position utilizing previously acquired time and position data for the snapshot receiver and by second pre-aligning each of the carrier phase measurements with integers that correspond to a magnitude of associated code-range measurements.

In another aspect of the embodiment, the IAR is a three-step process. The three-step process includes first calculating a float solution for both the code-range measurements and also the carrier phase measurements of the time-free observables and also both the code-range measurements and also the carrier-phase measurements of the time-referenced observables, the float solution being subjected to a double difference process to produce a double difference vector. Second, an integer estimation is performed upon the double difference vector to produce an integer vector. Finally, a re-calculation is performed of the float solution with the integer vector in order to produce the IAR.

In another embodiment of the invention, a data processing system is adapted for time-free position determination of a roving receiver using a reference receiver. The system includes a host computing platform that includes one or more computers, each with memory and at least one processor. The host computing platform has a communicative coupling over computer communications network to a snapshot receiver. The snapshot receiver is adapted to receive time-free observables disposed within a snapshot position of the snapshot receiver, the snapshot position having been received by the snapshot receiver for only a single epoch and the snapshot position having been received from a constellation of global positioning satellites. The host computing platform additionally has a communicative coupling over the computer communications network to a fixed receiver adapted to receive baseline position data for the fixed receiver from the constellation, the baseline position data comprising time-referenced observables.

Finally, the system includes a time-free position determination module. The module includes computer program instructions enabled while executing in the host computing platform to acquire the snapshot position of the snapshot receiver. The program instructions also are enabled to retrieve the baseline position data of the fixed receiver. Finally, the program instructions are enabled to composite the time-free observables of the snapshot position with the time referenced observables of the baseline position data to produce time and position data for the snapshot receiver.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is pictorial illustration of a process for time-free position determination of a roving receiver using a reference receiver;

FIG. 2 is a schematic diagram showing a computing architecture for a data processing system adapted for time-free position determination of a roving receiver using a reference receiver; and,

FIG. 3 is a flow chart illustrating a process for time-free position determination of a roving receiver using a reference receiver.

### DETAILED DESCRIPTION OF THE INVENTION

Embodiments of the invention provide for time-free position determination of a roving receiver using a reference receiver. In accordance with an embodiment of the inventive arrangements, over a single epoch, time-free positioning data is received in a snapshot RTK receiver from four or more positioning satellites in a global positioning satellite constellation. The time-free positioning data includes by way of example, both code-range measurements and corresponding carrier phase measurements. As well, baseline positioning data for a fixed receiver which differs from the snapshot RTK receiver may be received from the same constellation, the baseline positioning data including time-referenced observables. Finally, the time-free positioning data of the snapshot position are composited with the time referenced observables of the baseline position data to produce time and position data for the snapshot receiver, by computing an integer ambiguity resolution (IAR) for the time-free positioning data based upon both the code-range measurements and also the carrier phase measurements and also code-range measurements and carrier-phase measurements of the time-referenced observables.

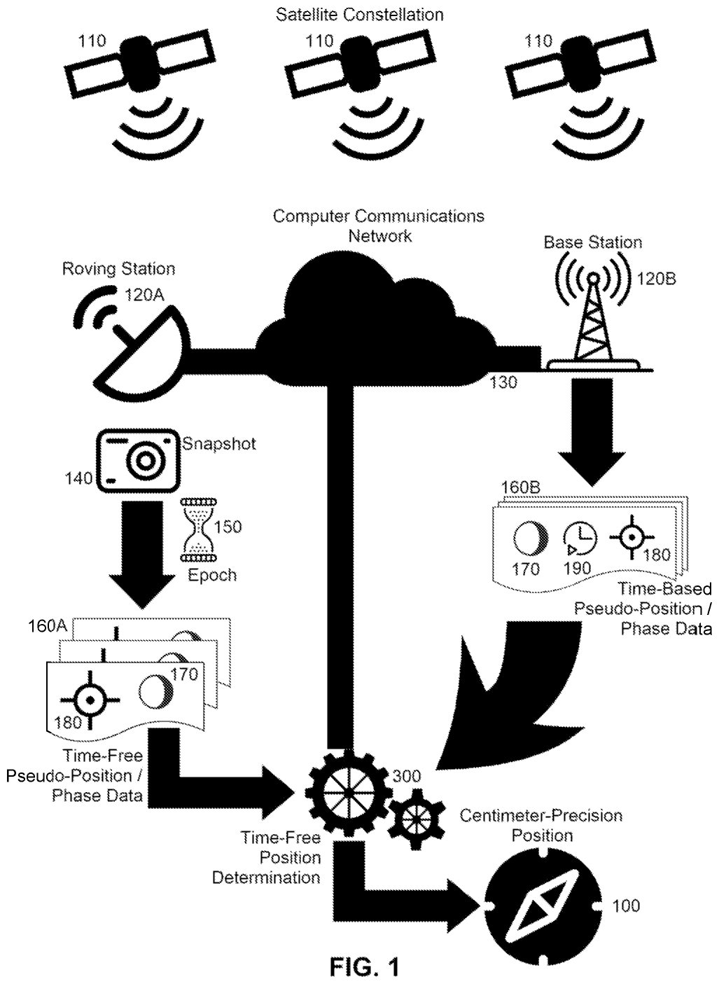

In further illustration, FIG. 1 pictorially shows a process for time-free position determination of a roving receiver using a reference receiver. As shown in FIG. 1, a roving station 120A with snapshot RTK receiver receives a snapshot 140 of a time-free set of observables 160A of carrier phase measurements 170 and code-range measurements 180 over a single epoch 150 from four or more satellites 110 in a GNSS constellation. Concurrently, a base station 120B receives time-based observables 160B from the satellites 110 in the GNSS constellation including not just carrier phase measurements 170 and code-range measurements 180, but also timing information 190 regarding the transmission of the carrier phase measurements 170 and code-range measurements 180.

Both the roving station 120A and the base station 120B provide the respective observables 160A, 160B over computer communications network 130 to time-free position determination module 300. The time-free position determination module 300 tunes the time-free observables 160A of carrier phase measurements 170 and code-range measurements 180 from the snapshot 140 using the time-based observables 160B of the carrier phase measurements 170 and code-range measurements 180 along with the timing information 190 in order to produce a centimeter precision position 100 of the roving station 120A. In this way, the roving station 120A can be of smaller size with reduced power consumption collecting the snapshot 140 over only a single epoch 150 without sacrificing the ability to produce the centimeter-precision position 100 of the roving station 120A.

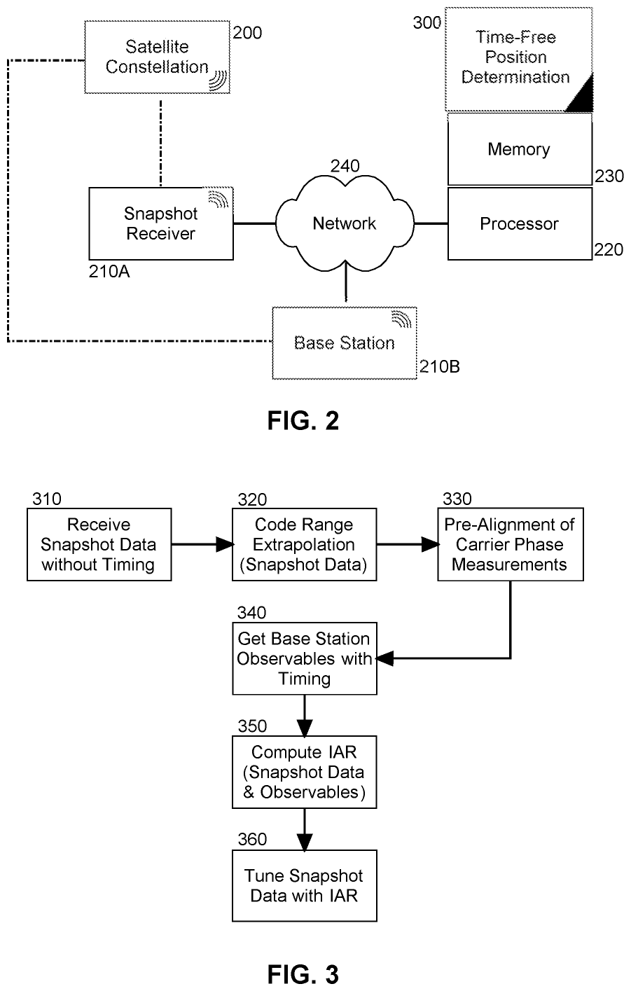

The process described in connection with FIG. 1 can be implemented within a data processing system. In further illustration, FIG. 2 schematic shows a computing architecture for a data processing system adapted for time-free position determination of a roving receiver using a reference receiver. The system includes a host computing platform that includes a processor 220 and memory 230 and is communicatively coupled over computer communications network 240 to both a snapshot receiver 210A and also a base station 210B, both of which in turn receive positioning data from a satellite constellation 200. A time-free position determination module 300 executes in the memory 230 by the processor 220 of the host computing platform.

The time-free position determination module 300 includes computer program instructions operable upon execution by the processor 220 in the memory 230 to produce a centimeter-precision position of the snapshot receiver 210A by tuning time-free snapshot data received by the snapshot receiver 210 from the satellite constellation 200 over only a single epoch, with time-based observables received in the base station 210B also from the satellite constellation 200. In particular, the program instructions are operable to first pre-process the time-free snapshot data of both code-range measurements and carrier phase measurements with an extrapolation of a partial set of code-range measurements into a full set of code-range measurements, and then to align the carrier phase measurements according to integer wavelengths. Then, the program instructions are operable to compute IAR for the pre-processed time-free snapshot data of the snapshot receiver 210A utilizing the time-based observables of the base station 210B. Finally, the computed IAR is applied to the pre-processed time-free snapshot data in order to produce the centimeter-precision position of the snapshot receiver 210.

In even yet further illustration of the operation of the program instructions of the time-free position determination module 300, FIG. 3 is a flow chart illustrating a process for time-free position determination of a roving receiver using a reference receiver. Beginning in block 310, time-free snapshot for only a single epoch is received from the snapshot receiver 210A. In block 320, a code range extrapolation is performed upon the fractional code phases of the snapshot. These fractional values are complemented by full code periods to obtain the distance to the beginning of the starting edge of the secondary code. Then the satellite transmission time can be anchored based on the fact that GNSS secondary code edges are always aligned with the standard GNSS time. After the transmission time has been accurately computed, a common reception time will be set for all the satellites and the full pseudo-ranges are obtained by multiplying speed of light and the time difference between transmission and reception of each satellite signal.

As well, in block 330, a pre-alignment is performed upon the carrier phase measurements of the snapshot. Thereafter, in block 340, time-based observables are retrieved in connection with a base station. Those observables include not only code-range measurements and carrier-phase measurements, but also corresponding timing information pertaining to a time of transmission of the information from respective satellites in the satellite constellation. The involved quantities are defined as

tₜᵣₐₙₛ=τ+N*T_{C}+Round((t_{CT}−ρ_{CT}/C)T_{SC})*T_{SC};

P=c*(t_{reception}−tₜᵣₐₙₛ); Where: t ₜᵣₐₙₛis the satellite transmission time for one satellite; τrepresents the code phase and Nrepresents the number of full primary code periods inside the current secondary code, these two values are computed inside the acquisition module; T_{C} and T_{SC} are the primary and secondary code periods of this satellite, respectively; t_{CT} is the timing solution computed from the Coarse-Time filter which is a rough time and position solution that is an intermediate product of the time-free position determination module 300, and ρ_{CT} is the geometric range from the satellite position and the receiver position solution from the Coarse-Time filter; c is the speed of light; t_{reception} is the common reception time for all satellites and finally Pis the full pseudorange for the current satellite

In block 350, an IAR is computed for the extrapolated code-range measurements and the pre-aligned phase measurements, based upon the time-based observables of the base station. For instance, the IAR may be computed as a three-step process beginning with the calculation of a float solution for both the code-range measurements and also the carrier phase measurements of the time-free observables and also both the code-range measurements and also the carrier-phase measurements of the time-referenced observables. The float solution then can be subjected to a double difference process to produce a double difference vector which, in turn, can be integer estimated so as to produce an integer vector. Finally, the float solution can be recalculated with the integer vector in order to produce the IAR. Consequently, the snapshot can be tuned with the computed IAR in block 360 in order to produce a centimeter-precise position of the snapshot receiver.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network. The computer readable program instructions may execute entirely on the user's computer, partly on the user's computer, as a stand-alone software package, partly on the user's computer and partly on a remote computer or entirely on the remote computer or server. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “include”, “includes”, and/or “including,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for time-free position determination of a roving receiver using a reference receiver, the method comprising:
acquiring from a snapshot receiver from over a computer communications network in a cloud executing process, a snapshot position of the snapshot receiver received by the snapshot receiver for a single epoch from a constellation of global positioning satellites and comprising a multiplicity of time-free observables;
retrieving into the cloud executing process from over the computer communications network, baseline position data for a fixed receiver received from the constellation and comprising time-referenced observables;
compositing in the cloud executing process the time-free observables of the snapshot position with the time referenced observables of the baseline position data to produce time and position data for the snapshot receiver.

2. The method of claim 1, wherein the time-free observables are a set of code-range measurements and corresponding carrier phase measurements.

3. The method of claim 2, wherein the compositing comprises computing an integer ambiguity resolution (IAR) for the snapshot position based upon both the code-range measurements and also the carrier phase measurements of the time-free observables and also code-range measurements and carrier-phase measurements of the time-referenced observables.

4. The method of claim 3, wherein the time-free observables are pre-processed prior to IAR by first extrapolating a full set of code-range measurements for the snapshot position utilizing previously acquired time and position data for the snapshot receiver and by second pre-aligning each of the carrier phase measurements with integers that correspond to a magnitude of associated code-range measurements.

5. The method of claim 3, wherein the IAR is a three-step process that includes:
first a calculation of a float solution for both the code-range measurements and also the carrier phase measurements of the time-free observables and also both the code-range measurements and also the carrier-phase measurements of the time-referenced observables, the float solution being subjected to a double difference process to produce a double difference vector;
second, an integer estimation of the double difference vector to produce an integer vector; and,
third, a re-calculation of the float solution with the integer vector in order to produce the IAR.

6. A data processing system adapted for time-free position determination of a roving receiver using a reference receiver, the system comprising:
a host computing platform comprising one or more computers, each comprising memory and at least one processor, the host computing platform having a communicative coupling over computer communications network to a snapshot receiver adapted to receive time-free observables disposed within a snapshot position of the snapshot receiver received in the snapshot receiver for a single epoch from a constellation of global positioning satellites, the host computing platform additionally having a communicative coupling over the computer communications network to a fixed receiver adapted to receive baseline position data for the fixed receiver from the constellation, the baseline position data comprising time-referenced observables; and,
a time-free position determination module comprising computer program instructions enabled while executing in the host computing platform to perform:
acquiring the snapshot position of the snapshot receiver;
retrieving the baseline position data of the fixed receiver; and,
compositing the time-free observables of the snapshot position with the time referenced observables of the baseline position data to produce time and position data for the snapshot receiver.

7. The system of claim 6, wherein the time-free observables are a set of code-range measurements and corresponding carrier phase measurements.

8. The system of claim 7, wherein the compositing comprises computing an integer ambiguity resolution (IAR) for the snapshot position based upon both the code-range measurements and also the carrier phase measurements of the time-free observables and also code-range measurements and carrier-phase measurements of the time-referenced observables.

9. The system of claim 8, wherein the time-free observables are pre-processed prior to IAR by first extrapolating a full set of code-range measurements for the snapshot position utilizing previously acquired time and position data for the snapshot receiver and by second pre-aligning each of the carrier phase measurements with integers that correspond to a magnitude of associated code-range measurements.

10. The system of claim 9, wherein the IAR is a three-step process that includes:
first a calculation of a float solution for both the code-range measurements and also the carrier phase measurements of the time-free observables and also both the code-range measurements and also the carrier-phase measurements of the time-referenced observables, the float solution being subjected to a double difference process to produce a double difference vector;
second, an integer estimation of the double difference vector to produce an integer vector; and,
third, a re-calculation of the float solution with the integer vector in order to produce the IAR.

11. A computer program product for time-free position determination of a roving receiver using a reference receiver, the computer program product including a computer readable storage medium having program instructions embodied therewith, the program instructions executable by a device to cause the device to perform a method including:
acquiring from a snapshot receiver from over a computer communications network in a cloud executing process, a snapshot position of the snapshot receiver received by the snapshot receiver for a single epoch from a constellation of global positioning satellites and comprising a multiplicity of time-free observables;
retrieving into the cloud executing process from over the computer communications network, baseline position data for a fixed receiver received from the constellation and comprising time-referenced observables;
compositing in the cloud executing process the time-free observables of the snapshot position with the time referenced observables of the baseline position data to produce time and position data for the snapshot receiver.

12. The computer program product of claim 11, wherein the time-free observables are a set of code-range measurements and corresponding carrier phase measurements.

13. The computer program product of claim 12, wherein the compositing comprises computing an integer ambiguity resolution (IAR) for the snapshot position based upon both the code-range measurements and also the carrier phase measurements of the time-free observables and also code-range measurements and carrier-phase measurements of the time-referenced observables.

14. The computer program product of claim 13, wherein the time-free observables are pre-processed prior to IAR by first extrapolating a full set of code-range measurements for the snapshot position utilizing previously acquired time and position data for the snapshot receiver and by second pre-aligning each of the carrier phase measurements with integers that correspond to a magnitude of associated code-range measurements.

15. The computer program product of claim 13, wherein the IAR is a three-step process that includes:
first a calculation of a float solution for both the code-range measurements and also the carrier phase measurements of the time-free observables and also both the code-range measurements and also the carrier-phase measurements of the time-referenced observables, the float solution being subjected to a double difference process to produce a double difference vector;
second, an integer estimation of the double difference vector to produce an integer vector; and,
third, a re-calculation of the float solution with the integer vector in order to produce the IAR.
